(19) United States
(12) Patent Application Publication
(10) Pub. No.: US 2014/0242908 A1
(43) Pub. Date: Aug. 28, 2014

(54) Combination Process Interaction

(71) Applicant: Creating Revolutions LLC, Miami, FL (US)

(72) Inventor: Einar Rosenberg, Miami, FL (US)

(73) Assignee: Creating Revolutions LLC, Miami, FL (US)

(21) Appl. No.: 14/170,775

(22) Filed: Feb. 3, 2014

Related U.S. Application Data
(60) Provisional application No. 61/760,019, filed on Feb. 1, 2013.

(51) Int. Cl. H04B 5/00

(52) U.S. Cl. CPC H04B 5/0056
USPC 455/41.1

(57) ABSTRACT

A method for applying the application of reading multiple NFC tags. By examining the context of the reading, the identification of the NFC tags, and a direction, pattern and/or sequence of reading, a corresponding action is determined and requested.

### CROSS REFERENCE TO RELATED APPLICATION

This application claims the benefit of U.S. provisional patent application No. 61/760,019, filed Feb. 1, 2013, the disclosure of which is incorporated herein by reference in its entirety.

### BACKGROUND OF THE INVENTION

Today, Near Field Communication (“NFC”) allows for simplifying certain actions, especially forming communication pairs, e.g., such as pairing a Bluetooth headset to a mobile communication device. Rather than going through the settings to pair Bluetooth devices, NFC allows for a single tap of the Bluetooth headset to initiate and complete secure pairing. There are many other examples where NFC today creates simplicity. Yet in most cases, it can only initiate a single, predefined action. If you want to control variations of actions, you can currently only use NFC as an initiator of the action and then have to interact with the mobile communication device using the touch screen to define unique variations of an action. An example of this would be using the NFC mobile communication device to tap a tag and open an application, but once the application is opened, you need to use the mobile communication device's touch screen to interact and initiate unique actions or variations of actions within the app. The ease of physically taping or waving your mobile communication device over a surface where an NFC tag is located is the key which makes NFC intuitive and simple.

In conventional systems, close proximity communication or short range communication technologies, e.g., NFC enabled mobile communication devices can “read” —e.g., receive data from—other close proximity enabled devices, e.g., NFC Tags. The NFC mobile communication device “taps” —places the NFC mobile communication device within the communication range of the NFC tag—the NFC tag, to read the data from the NFC tag. The close proximity communication standards enable very open communications between close proximity communication devices. Unlike Bluetooth communications which occur over several feet and thus desire some protection from unwanted access, close proximity communication usually occur within ten centimeters and do not generally require passwords for close proximity communication devices to communicate. However, close proximity communication standards require that the communications occur in close proximity, i.e., generally within ten centimeters, in the “Near Field”, even though close proximity communication tags, e.g., NFC tags, are generally passive and the close proximity communication mobile communication device provides the energy to activate the close proximity communication tag and communicates with the close proximity communication tag. Although referred to generally as the mobile communication device performing actions, it is commonly understood that it is more specifically referring to the appropriate hardware and appropriate software of the mobile communication device working generally together.

NFC tags and similar devices are very desirable to use. NFC tags used to be relatively expensive but are currently relatively inexpensive. NFC tags are relatively small, non-obtrusive, and very light; as such, they are easy to employ in a variety of locations without their placement being detracting from the utilitarian and non-utilitarian of their context. Conventional NFC tags are approximately one inch square or smaller and almost paper thin. Custom NFC tags can be as small as 1 mm square and almost paper thin. Although there is generally a tradeoff of size versus power/data storage, the NFC tag efficiency has significantly increased over the years. NFC tags are passive require no constant power source—their power source is received from the NFC reader. In the not too distant future 3M printers or analogous systems will enable a user's to “print” custom NFC tags at home.

In accordance with NFC standards and protocols, an NFC mobile communication device receives the data from an NFC tag and interprets the data. This data interpreted by the NFC mobile communication device will result in some action by the mobile communication device related to the data. If the data is informational data, then the mobile communication device's action is, for example, storing the informational data for later use. If the data is a command, then when an NFC mobile communication device reads the data from an NFC tag, the NFC mobile communication device interprets the command and the command causes the mobile communication device to perform an action(s), e.g., open a specific web page or start a specific app. Subsequently, the user can then observe and/or interact with the web page or the specific app using the standard interaction methodology of the mobile communication device such as using the touch screen or physical features the mobile communication device (e.g., keyboard, built in motion detection features, etc.). Additionally, there is NFC tag data which when interpreted by an NFC mobile communication device will result in the mobile communication device running a defined sets of instructions. Generally the instruction is narrow, so when an NFC tag is read, the data from the tag causes the mobile communication device to execute a process which includes narrowly defined actions. This is similar to using macros on a computer. While these can initiate multiple steps of actions, they are narrowly defined and have little to no control or modification ability from the user who touched the specific NFC tag.

Further, in accordance with NFC standards and protocols, conventional methods of a NFC mobile communication device reading NFC tags limit reading commands from an NFC tag to a single or more actions. A single action is, for example, to turn on the Bluetooth feature on a user's mobile communication device. For example, a user enters their car and taps their NFC mobile communication device on an NFC tag in the car. The data on the NFC tag contains instructions which the mobile communication device interprets to turn on its Bluetooth. Once the mobile communication device has interpreted the instructions the mobile communication device executes the instruction resulting in the mobile communication device turning on its Bluetooth. The NFC tag data can also includes several actions. For example, the NFC tag has an instruction to turn on the mobile communication device's Bluetooth feature and other instruction to turn on the mobile communication device's GPS feature. For example, a user enters their car and taps their NFC mobile communication device on an NFC tag in the car. The data on the NFC tag contains instructions which the mobile communication device interprets to turn on its Bluetooth and GPS feature. Once the mobile communication device has interpreted the instructions the mobile communication device executes the instruction resulting in the mobile communication device turning on its Bluetooth and its GPS features.

In another example of narrowly defined actions, the data on a NFC tag includes instructions where mobile communication device's Bluetooth feature will toggle whether it is on or off. Thus, when a user taps their mobile communication device to an NFC tag, it can turn on the Bluetooth if it's off, and if it is on, it can have instructions to turn the Bluetooth off. But if the user wishes more interactive actions with their NFC phone, they have to open settings in Bluetooth and interact with the NFC phone via the touch screen.

In another limitation, conventional users would have actions where the user has to tap multiple NFC tags with each tag predefined, with narrowly defined actions. However, these instructions are static and not dynamic. For an example, if a NFC tag includes instructions that turns on both the Bluetooth and the GPS, as in the example above, when the user enters their car and taps the NFC tag. However, if the user wants different results, for example, if the user wishes have the mobile communication device turn on only the Bluetooth but not the GPS, then either the user will have to turn on the Bluetooth manually and not use the NFC tag, or he can tap the NFC tag and then manually turn off the GPS. Alternatively, the user can employ two NFC tags in the car, with each NFC tag having a single command, and the user only tap the NFC tag corresponding to turning on the Bluetooth feature. In this latter scenario, each tag in this case representing a different narrowed action. By extension, if a user desired individual wanted control of ten actions, then this would require employing NFC tags for each of the respective ten actions. This could be visually unappealing, cumbersome, and not user friendly.

It would be desirable to have a command in a NFC tag data capable of incorporating input to provide dynamic results, rather than static results. Further it would be desirable to use the data from more than one NFC tag as part of a single operation thus give a user, through an NFC mobile communication device, the ability to uniquely control multiple possible actions and variations of actions by motioning the mobile communication device over a grouping of NFC tags as the mobile communication device reads the unique combinations of Tags with such motioning of the mobile communication device.

### BRIEF DESCRIPTION OF THE DRAWINGS

FIG. 1 depicts an mobile communication device communicating with NFC tags according to an exemplary embodiment of the invention;

FIG. 2 depicts an exemplary application of a Directional Flow for control in accordance with another embodiment of the invention;

FIG. 3 depicts an exemplary process flow for using the directional flow in accordance with FIG. 2;

FIG. 4 depicts an exemplary look-up table corresponding the directional flow example of FIGS. 2 and 3;

FIG. 5 depicts an exemplary application of a Directional Flow for control in accordance with another embodiment of the invention;

FIG. 6 depicts an exemplary process flow for using the directional flow in accordance with FIG. 5;

FIG. 7 depicts an exemplary look-up table corresponding the directional flow example of FIGS. 5 and 6;

FIG. 8 depicts an exemplary application of a Sequential Flow for control in accordance with another embodiment of the invention;

FIG. 9 depicts an exemplary process flow for using the directional flow in accordance with FIG. 8;

FIG. 10 depicts an exemplary look-up table corresponding the directional flow example of FIGS. 8 and 9;

FIG. 11 depicts an exemplary application of Pattern flow;

FIGS. 12(a) and 12(b) depict an example application of Pattern flow according to FIG. 11;

FIG. 13 depicts an exemplary process flow for using the directional flow in accordance with FIGS. 11 and 12(a); and

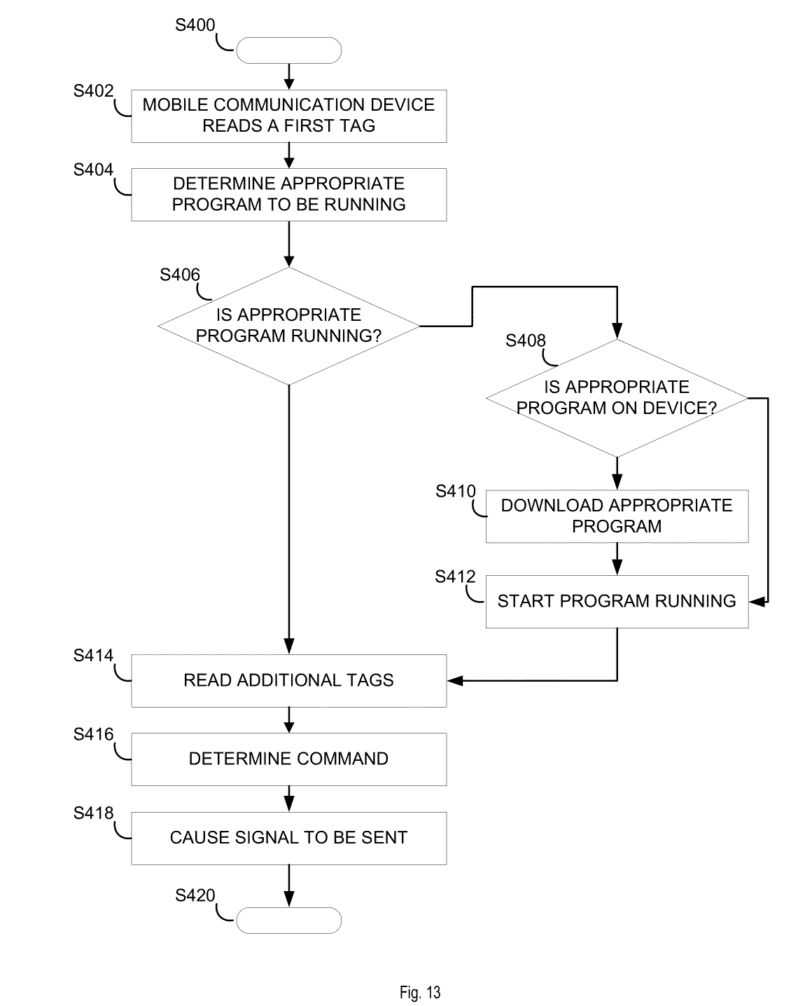

FIG. 14 depicts an exemplary look-up table corresponding to the directional flow example of FIGS. 11, 12(a), and 13.

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

The invention discloses a method, apparatus, and system to provide more dynamic results when reading close proximity communication tags. More specifically, an embodiment of the invention uses more than one close proximity communication tags, as part of a single operation thus providing a user, through their close proximity communication mobile communication device, the ability to uniquely control multiple possible actions and variations of actions. Each combination of tags being read has a respective result or action that should occur. The invention discloses a system and method of using a close proximity communication mobile communication device and multiple close proximity communication Tags to provide, depending on the context, pattern, directional path, or sequence of reading those close proximity communication Tags, initiating specific actions or variations actions on the mobile communication device or communicated from the mobile communication device to another computer system. As the user motions their NFC mobile communication device over the NFC Tags which are strategically positioned on a surface, the NFC mobile communication device reads and relays to the system the sequence, pattern, or directional path in which the reads of the NFC tags are being done. The unique sequence, pattern, and/or direction path, can define a unique action or variation of an action. Though the use of NFC tags is discussed in the invention, the invention is not so limited. In many applications, NFC Tags can be replaced with similar technologies such as Bluetooth Low Energy, 2D Barcodes, Color Symbols, Shapes, LED, and other such close proximity technologies.

An appropriate program, e.g., an app, api, etc., preferably being executed on a mobile communication device, interpreting the reading of the close proximity communication tags (e.g., the data read from the NFC tags) is programmed to discern the context, different sequences, patterns, and/or directional paths as determined by the order in which close proximity communication tags are read. For example, if there three close proximity communication tags A, B, and C, in a row, there are several different ways in which the mobile communication device can read three tags. Assuming that each tag will only be read once, then the close proximity communication tags can be read as: “A, B, C”, “A, C, B”, “B, A, C”, “B, C, A”, “C, A, B”, and “C, B, A.” For each possible combination of sequences, patterns, and/or directional paths, the system is programmed to apply an action(s) or result(s). Thus, for “A, B, C” the system would apply a first action, for “C, B, A” the system would apply a second action and for “B, C, A” would apply a third action. Reading a tag more than once creates an increased number of possible results. Thus, reading “A, A, B” would create a first action. “B, B, B” would create a second action.

The system interprets the combination of sequence, patterns, and/or directional paths to initiate an action or a variation of an action. As a result, this increases the opportunities to interact with the mobile communication device or with secondary connected systems communicating with the mobile communication device.

In an aspect, the invention discloses using multiple close proximity communication tags strategically placed on a surface, and motioning the close proximity communication mobile communication device to read a specific sequence or pattern of close proximity communication mobile communication tags to define unique actions or variations of actions. Using one of the invention's methods allows for multiple motions of tapping, waving an NFC mobile communication device to read a grouping of NFC tags in a specific sequence or pattern, to initiate user defined unique actions and variations of actions. Any surface such as a wall or table can become a control board to control, inform or define anything from dimming a light to controlling a spaceship, and many other possible uses.

There exist several exemplary process methods for this invention: Directional Flow, Sequence Flow, and Pattern Flow. A Directional flow method is the reading of tags in a specific direction which results to control variations or selections. This method uses a reading action of a close proximity mobile communication device placed over a part of or all of a substantially linear path of close proximity communication tags preferably laid out on a surface. For example, directional flow method is applied to be used as a controller like a light dimmer or a slide menu selector. This method is discussed in greater detail below.

In a Sequence Flow method approach, close proximity communication tags are not read necessarily read in a linear path but instead a close proximity communication mobile communication device reads tags anywhere in the field of available close proximity communication tags in a specific order. The sequence of reading close proximity communication tags provides and/or defines a unique action or variation of an action. For example, if you had three NFC tags and the system expects three tags to be read, then there are twenty seven possible sequences possible of reading three tags. Twenty seven possible sequences can create twenty seven possible actions or variations of actions. This method is described in greater detail below.

A Pattern flow method uses reading tags in a unique pattern. This method uses a guided path such as virtually drawing with a paint brush, where the NFC mobile communication device is the paint brush and the grid or layout of the NFC tags on a surface is the canvas. For example, pattern flow can be used to control variations of diming using a circular motion, or writing the letter S virtually by waving the mobile communication device over a grid of NFC tags to define to the system that the pattern was read is the letter S. This method is described in greater detail below.

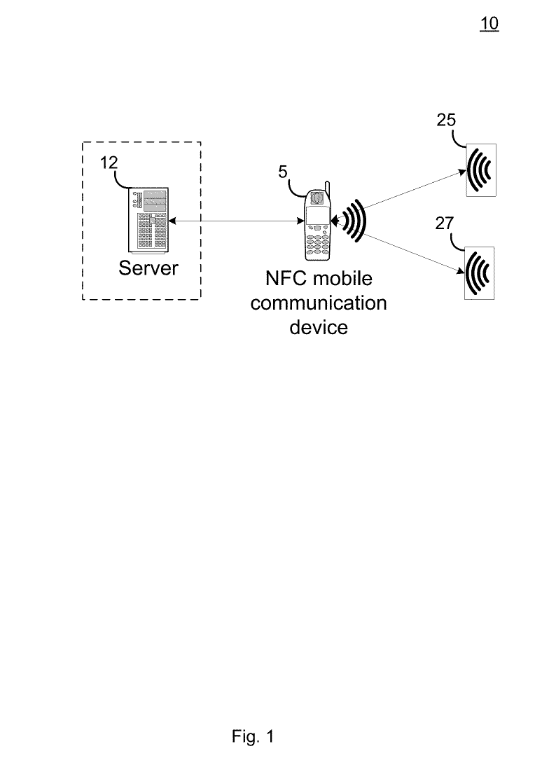

FIG. 1 depicts a mobile communication device communicating with close proximity communication tags according to an exemplary approach of the invention. System 10 includes a close proximity communication enabled mobile communication device 5, NFC tags 25, 27, and, optionally, a server 12. The mobile communication device 5 is a close proximity communication, e.g., NFC enabled mobile communication device, thus can read close proximity communication, e.g., NFC, tags, and can also generally close proximity communication communications to communicate with other close proximity communication devices. Generally, a close proximity communication mobile communication device have at least one close proximity communication communications program (e.g., an app or API) that commences execution during system start up and runs as a background process. When the mobile communication device comes into the close proximity range of another enabled close proximity communication device, the close proximity communication program performs or causes other parts of the mobile communication device to perform near field communications with the other close proximity communication device. The close proximity communication program receives data from the close proximity communication device.

The mobile communication device 5 is preferably running an appropriate program for the context of the other NFC device. In an approach, a user selects the appropriate program to run on the mobile communication device. In another approach, part of the data received from the NFC device indicates the appropriate program to be running. Preferably, the mobile communication device's inherent or built in or built on NFC features of the mobile communication device's OS looks for the appropriate program, and if it isn't already executing, then using part of the data received from the NFC device, the operating system determines where to download the appropriate program from, causing the program to be downloaded, installed and executed. The appropriate program uses part of the data to determine what to do. For example, the appropriate program causes the mobile communication device to perform some action, e.g., to get input from the user.

NFC tags 25, 27 are close proximity communication tags, e.g., NFC tags, that have data, e.g., unique identifiers, stored on them, respectively. Preferably, tag 25 has a unique identifier different from tag 27 such that when the tags are read by an NFC reader, the reader can distinguish and identify each tag. In an aspect, the tag data also includes information providing information as to the context of the placement or scenario of the tags. In an aspect, the tag data also includes information providing information as to an appropriate program that should be running on the mobile communication device 5.

System 10 includes an optional server 12 that can communicate with mobile communication device 5. System 10 is representational of either a single or multiple servers. Although embodiments of the invention may be described with the mobile communication device performing the program processing for the invention, the invention is not so limited, and some part or all of the processing maybe done by a server or other computational device.

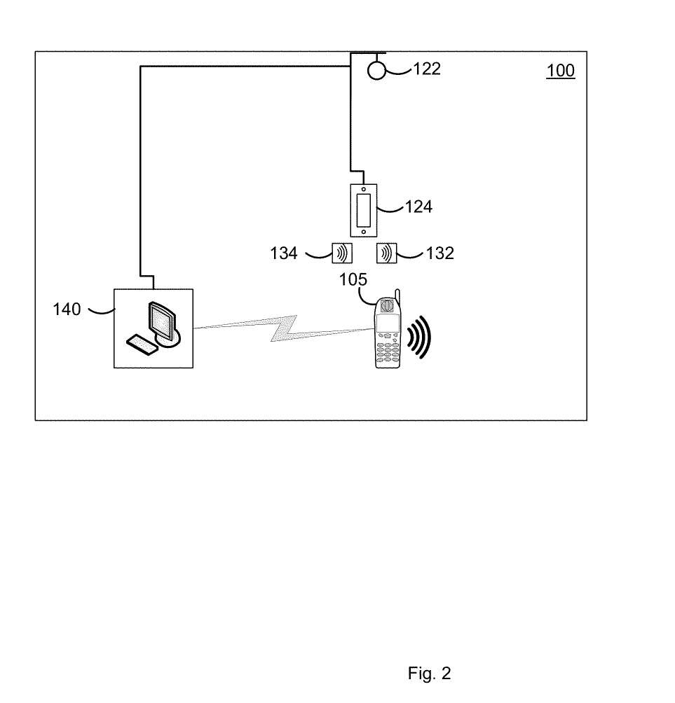

FIG. 2 depicts an exemplary application of a Directional Flow for binary control, e.g., to control turning a light on or off. The lights are controlled by a home automation server or control box connected to the light switch. The mobile communication device 5 reads the NFC tags via NFC and communicates to the home automation server or control box via a second communications method such as Wifi, Bluetooth, Cellular, Wireless USB, etc, providing a command as to whether the lights should be turned on or off.

System 100 is a room and includes a light 122 connected to a switch 124 which performs conventional operation of the light to be on or off. The system 10 also includes NFC tags 132, 134 in another location. Using Directional Flow Method of the invention, NFC tags 132, 134 are read, and able to mimic the actions of the light switch. Unlike the light switch, the NFC tags can be placed in any location, allowing for a user to place a light switch where they wish, to be able to control the lights of the room. The system 100 also includes NFC mobile communication device 105. System 100 also includes a home controller system 140.

In the exemplary approach, the mobile communication device 105 is placed over a NFC tag and reads the tag and then is placed over another NFC tag and reads that tag. The reading of these tags is done in a single motion by the user. Based on the information received from the tags and the order in which NFC 105 reads the tags, the appropriate program causes an action to occur. For example, if the mobile communication device 105 reads tag 132 and then reads tag 134, the appropriate program on the mobile communication device 105 interprets this as a command to turn on the light 122 and causes an appropriate signal to be sent to a light controller, e.g., home controller 140, to turn on the light. Further, if the mobile communication device 105 reads tag 134 and then reads tag 132, the appropriate program interprets this as a command to turn off the light 122 and causes an appropriate signal to be sent to a light controller to turn off the light.

Interpretation of the NFC tag information occurs on the mobile communication device, where the logic is running on a stand alone application, or can run on a third party app or api running on the operating system, that knows how to interpret the read of a certain combination of tags as being a specific action. The appropriate program can also provide the NFC tag data and provide it to a second computer system (e.g., sever 12 of FIG. 1). Thus, in an approach the mobile communication device 105 reads the tags and then using some communications system, e.g., via Wi-Fi, or Bluetooth, or cellular, it communicates the NFC tag data to a second computer system which interprets the reads and then either initiates an action based on this interpretation or sends instructions to the mobile communication device of the interpretation.

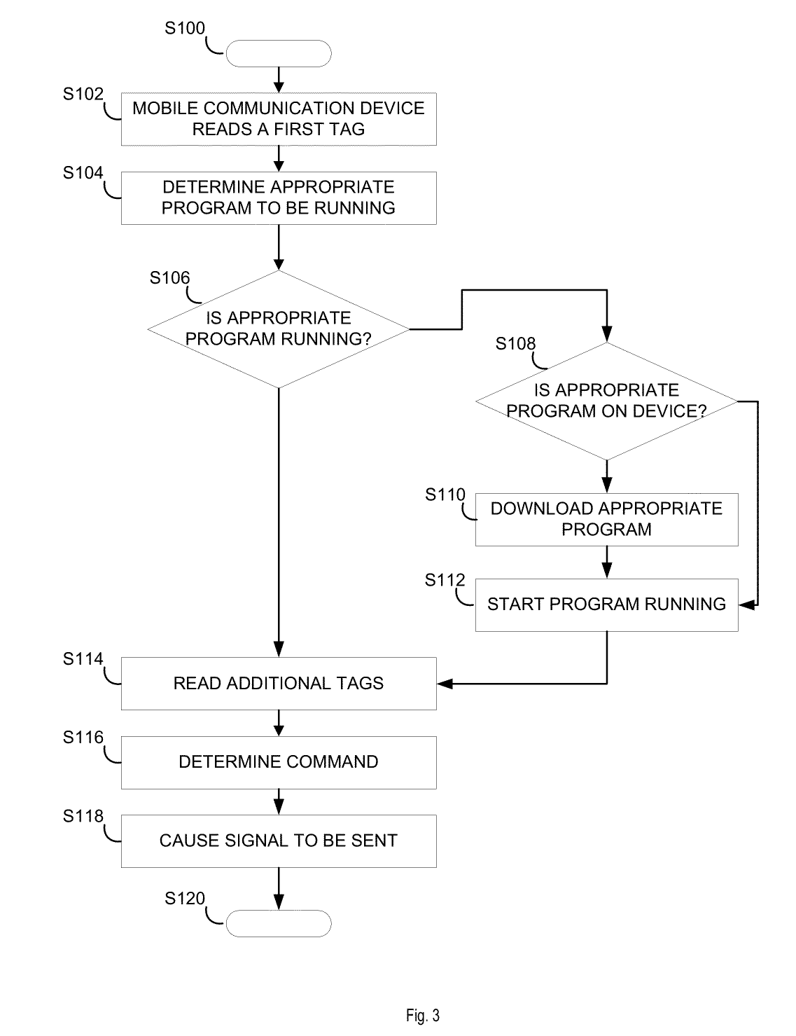

FIG. 3 is a flow chart depicting an exemplary process flow for using a mobile communication device to read tags in a directional flow. This process flow is based on an exemplary application of the system described with respect to FIG. 2.

The process starts at S100 and proceeds to segment S102.

In segment S102, the mobile communication device 105 using its standard NFC communication abilities reads a first tag, e.g., 132. Process continues to segment S104.

In segment S104, the mobile communication device interprets the data from the first tag. The mobile communication device determines the appropriate program to be running on the mobile communication device for the context determined by the scenario. For example, in this context, a light controlling interfacing with a home control program should be running, Process continues to segment S106.

In segment S106, the mobile communication device determines if it running the appropriate program. If it is not running then the process continues to segment S108. Otherwise process continues to segment S114.

In segment S108, the mobile communication device determines if the appropriate program resides on the mobile communication device. If the appropriate is not residing on the mobile communication device, then process continues to segment S110. Other process continues to segment 112.

In segment S110, the mobile communication device using conventional NFC abilities determines from the tag data and executes a process to make communication with an appropriate computer system and downloads the appropriate program on to the mobile communication device. Process continues to segment S112.

In segment S112, the mobile communication device starts the appropriate program executing . Process continues to segment S114.

In segment S114, the mobile communication device reads any additional tags. In this example, if tag 132 has previously been read, then tag 134 is likely to be read next. Process continues to segment S116.

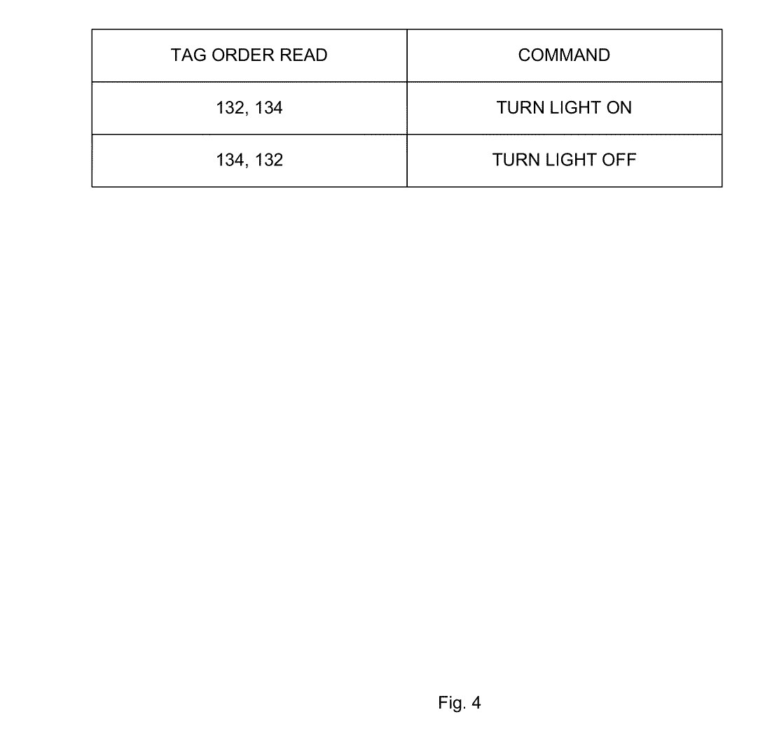

In segment S116, based on the tags read by the mobile communication device, the appropriate program determines what command should be sent. For example, the appropriate program on the mobile communication device includes a look-up table to determine the correspondence between tags read and command to be sent. An exemplary look up table is depicted in FIG. 4, which shows that if the tags are in the order 132, 134, then the command should be light on. If the tags are in the order 134, 132, then the command should be light off. Process continues to segment S118.

In segment S118, the appropriate program causes a “turn on” signal. Process continues to segment S120.

In segment S110, the process is complete.

Thus, at the end of the process, a light or some other comparable device, has been turned on or turned off depending on the command read by the mobile communication device.

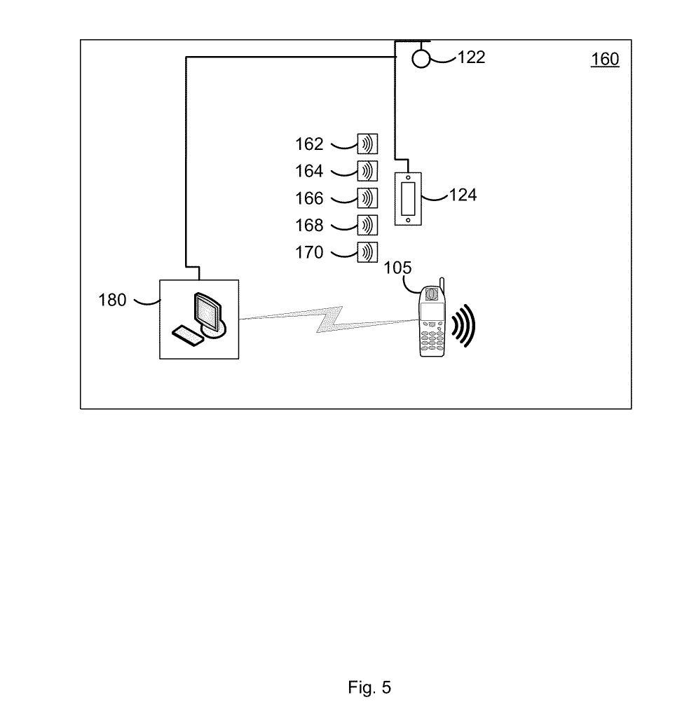

In another approach of a directional flow context, as depicted in FIG. 5, five NFC tags are lined up in a row on the wall, and on top of the NFC tags are symbols or images representing a virtual rheostat for light intensity. System 160 is a room and includes a light 122 connected to a switch 124 which performs conventional operation of the light to be on or off or dimmed. The system 160 also includes NFC tags 162, 164, 166, 168, 170 near the light switch 124. The system 160 also includes NFC mobile communication device 105 and home controller 180.

In an approach, NFC tags 162, 164, 166, 168, 170 establish the lineage for the virtual rheostat, where NFC tag 170 represents the most resistance, i.e., no light—the light is off, and NFC tag 162 represents the least resistance, i.e., full light—the light is on. NFC tags 164, 166, 168 represent resistance in between on and off, e.g., ¼, ½, ¾ resistance, respectively.

In the exemplary approach, the mobile communication device 105 is placed over a NFC tag and reads the tag and then is placed over another NFC tag and reads that tag. Based on the information received from the tags and the order in which NFC 105 reads the tags, the appropriate program causes an action to occur. For example, if the mobile communication device 105 reads tag 170 and then reads tags in a linear path to tag 168, the appropriate program interprets this as a command to turn on the light 122 and causes an appropriate signal to be sent to a light controller, e.g., home controller 180, to apply ¾ resistance and turn on the light to ¼ power. Further, if the mobile communication device 105 reads tag 162 and then reads tag 164 then in linear read path, tag 166, the appropriate program interprets this as a command to turn down the light 122 and causes an appropriate signal to be sent to a light controller, e.g., home controller 180, to apply ½ resistance, e.g., apply half power to the light. The image would show that if the user waves the NFC mobile communication device from the bottom of the row of NFC tags to the top of the row of NFC tags, the reads would define increasing or decreasing the light intensity.

In an aspect any of the tags in the sequence can be tapped and the respective action occurs. For example, if the light is currently at full power and a user wants to adjust the light to half power, the user can tap the sequence at the middle NFC tag and after the mobile communication device processes the signal from the tag, the mobile communication device would provide a signal to a light controller indicating to apply ½ resistance, e.g., apply half power to the light. In an aspect, the tags define the state in the full process, but also can each define the app or service to use.

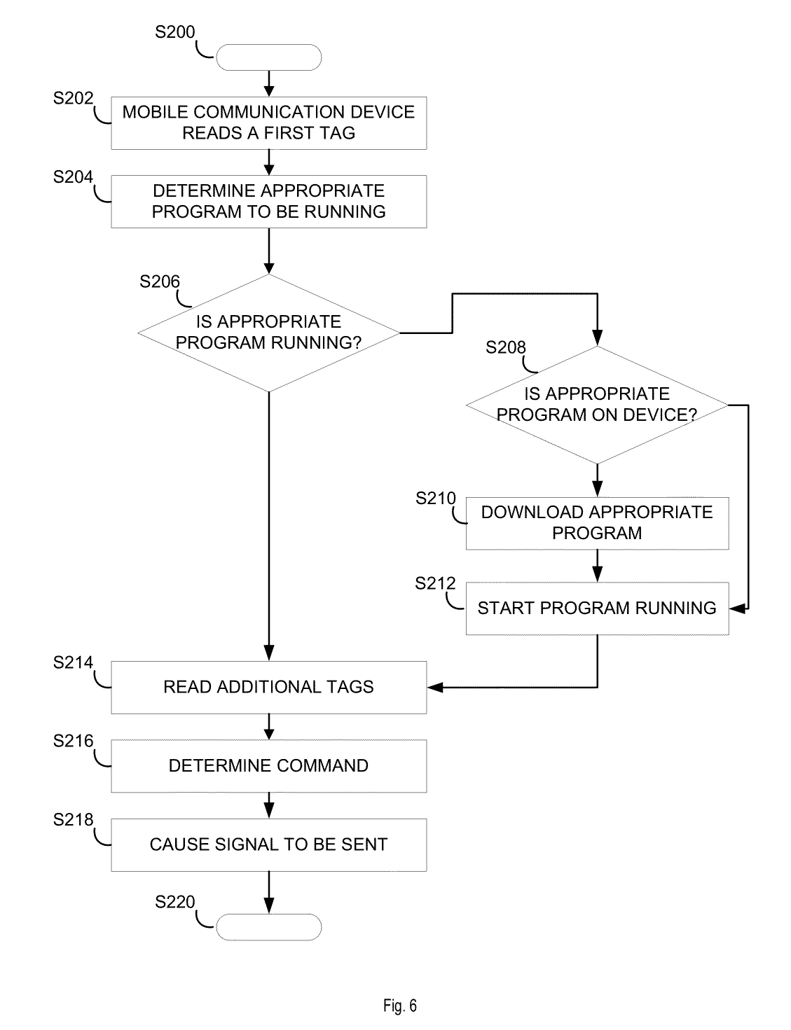

FIG. 6 is a flow chart depicting an exemplary process flow for using a mobile communication device to read tags in a directional flow. This process flow is based on an exemplary application of the system described with respect to FIG. 5.

The process starts at S200 and proceeds to segment S202.

In segment S202, the mobile communication device 105 using its standard NFC communication abilities reads a first tag, e.g., 162. Process continues to segment S204.

In segment S204, the mobile communication device interprets the data from the first tag. The mobile communication device determines the appropriate program to be running on the mobile communication device for the context determined by the scenario. For example, in this context, a light controlling interfacing with a home control program should be running, Process continues to segment S206.

In segment S206, the mobile communication device determines if it running the appropriate program. If it is not running then the process continues to segment S208. Otherwise process continues to segment S214.

In segment S208, the mobile communication device determines if the appropriate program resides on the mobile communication device. If the appropriate is not residing on the mobile communication device, then process continues to segment S210. Other process continues to segment S212.

In segment S210, the mobile communication device using conventional NFC abilities determines from the tag data and executes a process to make communication with an appropriate computer system and downloads the appropriate program on to the mobile communication device. Process continues to segment S212.

In segment S212, the mobile communication device starts the appropriate program executing . Process continues to segment S214.

In segment S214, the mobile communication device reads any additional tags. In this example, if tag 132 has previously been read, then tag 164 is read next and then tag 166 is read. Process continues to segment S216.

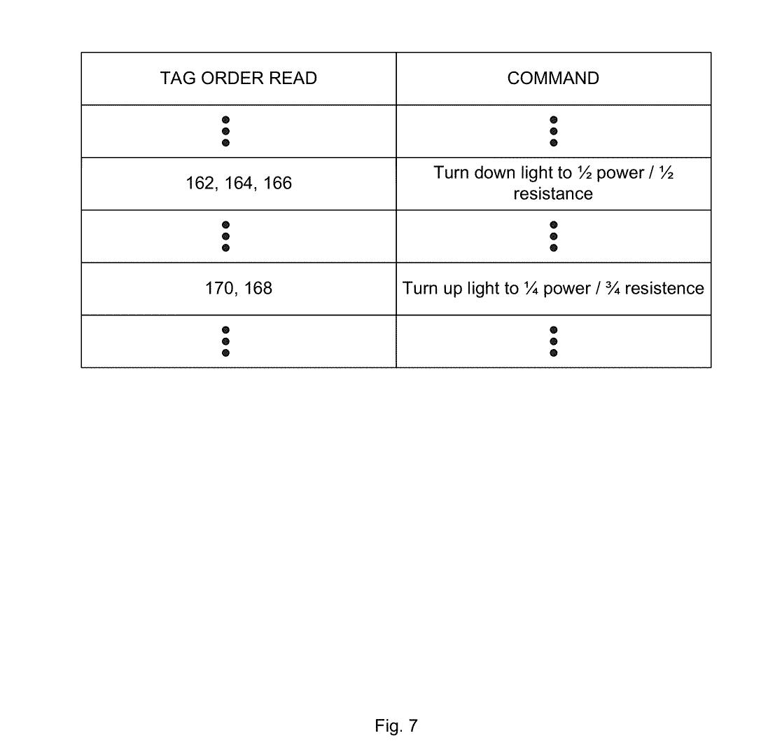

In segment S216, based on the tags read by the mobile communication device, the appropriate program determines what command should be sent. For example, the appropriate program on the mobile communication device includes a look-up table to determine the correspondence between tags read and command to be sent. An exemplary look up table is depicted in FIG. 7, which shows that if the tags are in the order 162, 164, 166, then the command should be light on half power. Process continues to segment S218.

In segment S218, the appropriate program causes a “turn down to half power” signal. Process continues to segment S220.

In segment S210, the process is complete.

Thus, at the end of the process, a light or some other comparable device, has been turned down to half power.

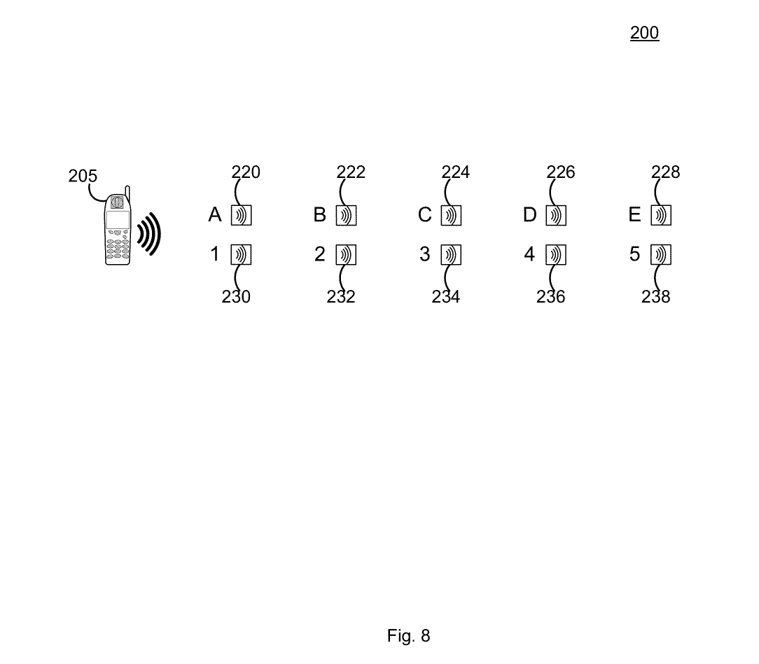

FIG. 8 depicts an exemplary application of a Sequential Flow context. System 200 includes a plurality of NFC tags 220, 222, 224, 226, 228, 230, 232, 234, 236, 238 and an NFC mobile communication device 205. Each NFC tag includes data that uniquely identifies it. A user uses a mobile communication device 305 to read a unique combination of the NFC tags in sequence to define a unique action or variation of an action.

For example, if the user uses the NFC mobile communication device 205 to read a sequence of NFC tags: NFC tag 222 B, NFC tag 226 D, NFC tag 228 E, NFC tag 238 5, the appropriate program on the mobile communication device 205 interprets which tags were read and the order in which they were read. The interpretation causes the appropriate program to cause a first action to be commenced. If the user taps sequence of tags a sequence of NFC tags: NFC tag 220 A, NFC tag 220 A, NFC tag 224 C, NFC tag 236 4, NFC tag 232 2, the appropriate program on the mobile communication device 205 interprets which tags were read and the order in which they were read. The interpretation causes the appropriate program to cause a second action to be commenced. Different sequences or combinations of sequences can define unique actions or variations of actions. Although depicted with ten NFC tags, the invention is not so limited and any number of NFC tags could be used. Further, although depicted with the NFC tags in substantially a rectangular pattern, the invention is not so limited and any arrangement of tags can be used.

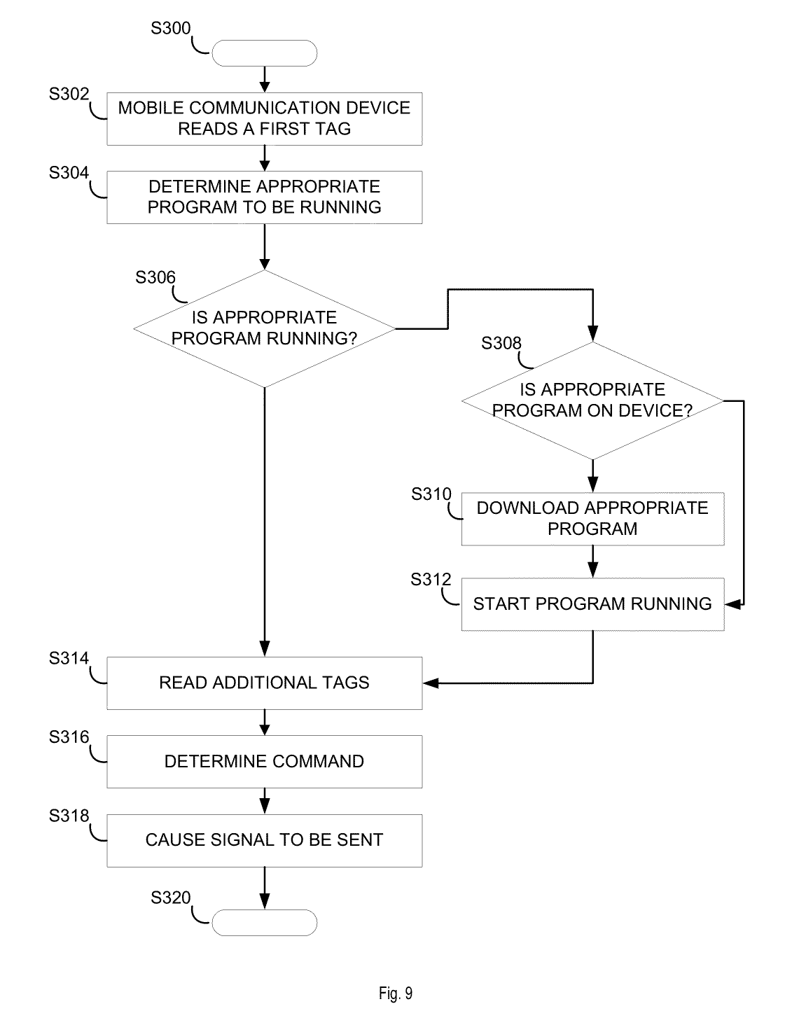

FIG. 9 is a flow chart depicting an exemplary process flow for using a mobile communication device to read tags in a sequential flow. This process flow is based on an exemplary application of the system described with respect to FIG. 8.

The process starts at S300 and proceeds to segment S302.

In segment S302, the mobile communication device 105 using its standard NFC communication abilities reads a first tag, e.g., 220A. Process continues to segment S304.

In segment S304, the mobile communication device interprets the data from the first tag. The mobile communication device determines the appropriate program to be running on the mobile communication device for the context determined by the scenario. In an aspect, any and all of the tags, regardless of which one was tapped first, can define which program to run. Process continues to segment S306.

In segment S306, the mobile communication device determines if it running the appropriate program. If it is not running then the process continues to segment S308. Otherwise process continues to segment S314.

In segment S308, the mobile communication device determines if the appropriate program resides on the mobile communication device. If the appropriate is not residing on the mobile communication device, then process continues to segment S310. Other process continues to segment S312.

In segment S310, the mobile communication device using conventional NFC abilities determines from the tag data and executes a process to make communication with an appropriate computer system and downloads the appropriate program on to the mobile communication device. Process continues to segment S312.

In segment S312, the mobile communication device starts the appropriate program executing . Process continues to segment S314.

In segment S314, the mobile communication device reads any additional tags. In this example, if tag 220 has previously been read, then tag 220 is read again, then tag 224 is read and then 236 and then 232 are read. Process continues to segment S316.

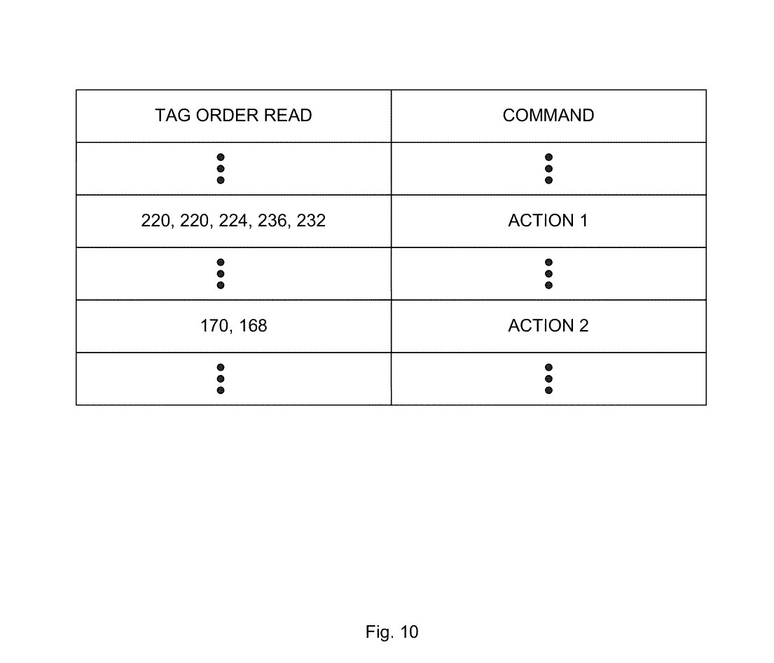

In segment S316, based on the tags read by the mobile communication device, the appropriate program determines what command should be sent. For example, the appropriate program on the mobile communication device includes a look-up table to determine the correspondence between tags read and command to be sent. An exemplary look up table is depicted in FIG. 10, which shows that if the tags are in the order 220, 220, 224, 236, 232, then the command should be a first action. Process continues to segment S318.

In segment S318, the appropriate program causes a “first action” signal to be sent. Where the signal is sent is dependent on the context. Process continues to segment S320.

In segment S310, the process is complete.

Thus, at the end of the process, the mobile communication device causes a first action signal to be provided to the appropriate receiver.

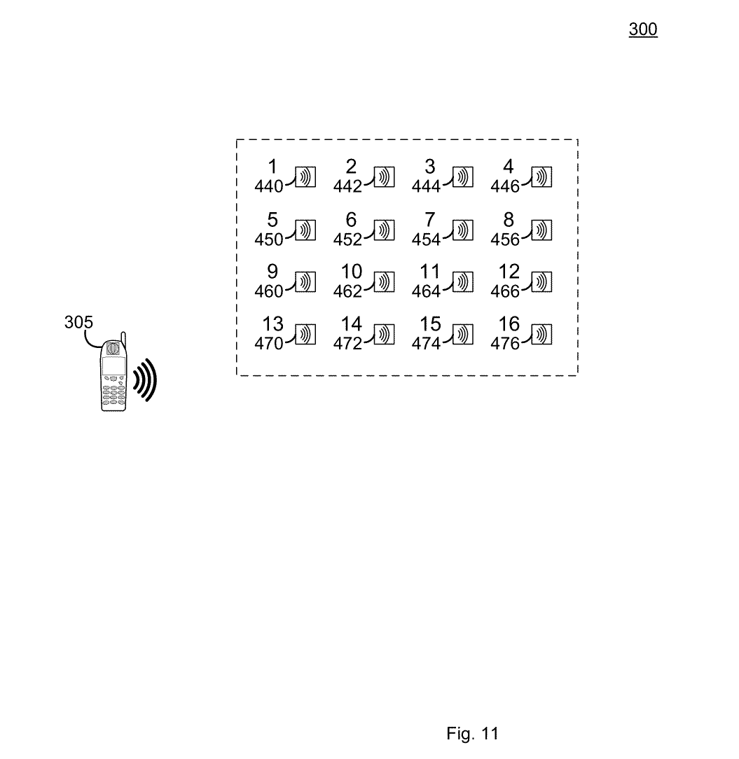

FIG. 11 depicts an exemplary application of Pattern flow. System 300 includes a plurality of NFC 440 tag 1, NFC 442 tag 2, NFC 444 tag 3, NFC 446 tag 4, NFC 450 tag 5, NFC 452 tag 6, NFC 454 tag 7, NFC 456 tag 8, NFC 460 tag 9, NFC 462 tag 10, NFC 464 tag 11, NFC 466 tag 12, NFC 470 tag 13, NFC 472 tag 14, NFC 474 tag 15, NFC 476 tag 16 and an NFC mobile communication device 305. Each NFC tag includes data that uniquely identifies it. A user uses a mobile communication device 305 to read a unique combination of NFC tags in sequence to define a unique pattern which causes action or variation of an action.

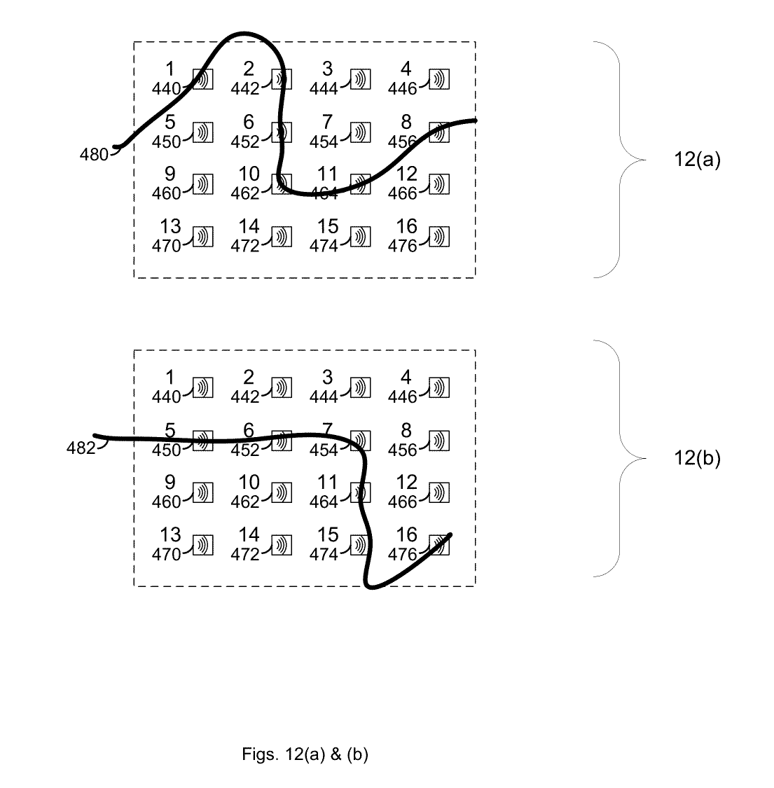

FIG. 12(a) depicts a first path 480 that a user using a mobile communication device 305 reads the NFC tags of FIG. 11. As it follows path 480, the mobile communication device 305 reads NFC TAG 440 1, NFC TAG 442 2, NFC TAG 452 6, NFC TAG 462 10, NFC TAG 464 11, AND NFC TAG 456 8. The appropriate program interprets this sequence of NFC tags and causes an action Alpha.

FIG. 12(b) depicts a second path 482 that a user using a mobile communication device 305 reads the NFC tags of FIG. 11. As it follows path 482, the mobile communication device 305 reads 450 5, NFC tag 452 6, NFC tag 454 7, NFC tag 464 11, NFC tag 474 15 and NFC tag 476 16. The appropriate program interprets this sequence of NFC tags and causes an action Beta. The pattern created can allow for a multitude of actions or variations of actions using this method.

FIG. 12 is a flow chart depicting an exemplary process flow for using a mobile communication device to read tags in a sequential flow. This process flow is based on an exemplary application of the system described with respect to FIGS. 11 and 12(a).

The process starts at S400 and proceeds to segment S402.

In segment S402, the mobile communication device 105 using its standard NFC communication abilities reads a first tag, e.g., NFC tag 440 1. Process continues to segment S404.

In segment S404, the mobile communication device interprets the data from the first tag . The mobile communication device determines the appropriate program to be running on the mobile communication device for the context determined by the scenario. Process continues to segment S406.

In segment S406, the mobile communication device determines if it running the appropriate program. If it is not running then the process continues to segment S408. Otherwise process continues to segment S414.

In segment S408, the mobile communication device determines if the appropriate program resides on the mobile communication device. If the appropriate is not residing on the mobile communication device, then process continues to segment S410. Other process continues to segment S412.

In segment S410, the mobile communication device using conventional NFC abilities determines from the tag data and executes a process to make communication with an appropriate computer system and downloads the appropriate program on to the mobile communication device. Process continues to segment S412.

In segment S412, the mobile communication device starts the appropriate program executing. Process continues to segment S414.

In segment S414, the mobile communication device reads any additional tags. In this example, NFC tag 442 2, NFC tag 452 6, NFC tag 462 10, NFC tag 464 11, and NFC tag 456 8 are read. Process continues to segment S416.

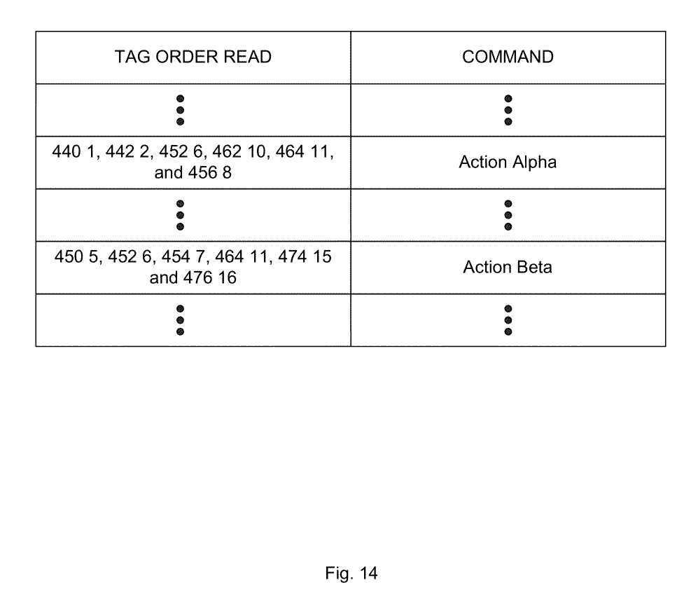

In segment S416, based on the tags read by the mobile communication device, the appropriate program determines what command should be sent. For example, the appropriate program on the mobile communication device includes a look-up table to determine the correspondence between tags read and command to be sent. An exemplary look up table is depicted in FIG. 14, which shows that if the tags are in the order NFC tag 440 1, NFC tag 442 2, NFC tag 452 6, NFC tag 462 10, NFC tag 464 11, and NFC tag 456 8, then the command should be Action Alpha. Process continues to segment S418.

In segment S418, the appropriate program causes a “Action Alpha” signal. Process continues to segment S420.

In segment S410, the process is complete.

Thus, at the end of the process, the mobile communication device read NFC tags and caused a corresponding signal, Action Alpha, to be sent.

The invention can be used in an exemplary approach to be used as a Joy Stick. Using the same screen on the mobile communication device or a second virtually connected screen, strategically placed tags representing 360 degree movement. Imagine a surface with multiple NFC tags strategically placed in a pattern creating a circle. In the middle of that circle is placed an NFC Tag. The middle NFC tag is the start point, where the users NFC phone is placed. On top of all the NFC tags is placed a graphic that hides the NFC tags, and shows to the user a bull's eye. The user knows how to motion with this system, to interact. They know that to start, they have to place their phone in the middle of the bull's eye. The system knows they are in the middle of the bull's eye because the phone is reading that the tag it's placed over currently is the middle NFC tag. If the phone motions 45 degrees up to the bulls eye outer ring, then the system knows this because it went from reading the middle NFC tag to the NFC tag placed strategically, 45 degree up from the middle NFC tag. This is interpreted by the system in this example, as the person pushing the joy stick up 45 degrees. The tags are read dynamically, and polled to the system. As the system dynamically reads the tags, it will know which sequence of tags are read and dynamically run the action or variation of action for that unique sequence. The dynamic read polling and interpretation of the sequence dynamically, are the key constructs of how the invention works. Therefore, motioning the mobile communication device over the tags can define the action or variation of action of what direction to move based on reading the specific corresponding tag that represents that direction. This is an example of directional flow in a non-linear path.

An example usage would be a spaceship video game. Using the tags to control the spaceships direction. The tags would have symbols on top of each, showing in this case, arrows to symbolize which angle of movement would correspond if the person where to move their NFC mobile communication device to read over that tag. That same surface could have other tags representing sequence flow such as having a tag with a symbol for laser and a tag with a symbol for bomb. If the user moves their mobile communication device to tap the tag corresponding laser, then the system would fire a laser. If they move their mobile communication device to tap the tag for bomb, it would launch a bomb. Placing tags on this surface in a linear pattern could be used with symbols for a racing game to represent how to accelerate or decelerate speed by reading the tags in an upward path to accelerate and reading the tags in a downward path for decelerations.

In another example a combination of the three methods described above to control a parking meter. On a surface such as a sign board, a tag is placed with the symbol for start and another tag is place next to it with a symbol for finish. The user can tap start, and then move to a grouping of tags in the middle of the board that are laid out in two columns of six NFC tags placed in three rows. The tags in the middle row have symbols for hours and minutes. The tags above those two tags have plus and minus symbols representing increase and decrease. The user can place their mobile communication device over the tag representing hours and then motion their mobile communication device up or down to read the tags above and below. This can then initiate a scroll wheel on the mobile communication device where the hours can be increased or decreased, and when the specific hour is reached via the increase/decrease motion, the user motions the mobile communication device back to the middle tag with the hour symbol, there by locking in the hour. The same can be used to define minutes. Once completed, they motion their mobile communication device to reach the tag on the surface with the symbol for finish to represent completion of the actions. This is an example of a control board setup where the motioning of the NFC mobile communication device over strategically placed NFC tags on a surface can allow control inputs, decisions, and information exchange with a secondary connected system using either the mobile communication device as a visual display of the actions or a second screen such as a monitor, displaying actions.

In another embodiment of the invention, this technology can be used for visually impaired persons to interact with a secondary system via motion actions using their NFC mobile communication device. For example, the NFC tags can be placed in a linear sequence. The visually impaired person knows that there is an NFC combination process surface in front of them. They motion their mobile communication device over the surface until the mobile communication device reacts via auditory or haptic feedback. The visually impaired person now knows they are in the vicinity of the NFC tags and the feedback defines to them how the sequence or pattern of tags are laid out, and the position of that specific tag in the sequence their NFC mobile communication device is currently over. In this example we are assuming it's a linear sequence of 5 NFC tags. The tags are uniquely defined as tags A, B, C, D, and E. The visually impaired person has been informed via feedback, that their mobile communication device is currently placed over Tag D of 5 tags and can motion up and down for selection. The visually impaired person knowing there are 5 tags, knows that if they motion up, they are able to select Tags A, B, or C, and if they motion down, they can select Tag E. As they move over each tag, the mobile communication device informs them of the choice they are over. Once the user motions the mobile communication device to the correct choice, the user holds the mobile communication device for 3 seconds in that position and then the mobile communication device will know that this option is the selected option and informs the visually impaired person they have selected that option. This example shows a control board using NFC Combination

Process with non-visual feedback of options, position, and selection to enact an action or a variation of an action.

In another embodiment of the invention, the user has five NFC tags strategically placed in their car console, to form a T pattern. The user wishes to control 10 unique actions, each with variations on the actions. For example, the user wishes to turn on/off the Bluetooth, GPS, Wifi, Drive Mode App, Read SMS, and other applications, services or capabilities of their NFC Phone. In this example, the user can use one of two of the methods of the invention to accomplish full control of all ten actions. The user can use pattern flow, such as if they motion from the center of the t, up, down, up, middle, and left, then this can signal the system to recognize the pattern to turn on Bluetooth, turn on GPS, turn off Wifi. If the user motions a different tag reading pattern, starting from center tag, down, up, middle, left, right. This can initiate another sequence of actions or variations of actions. In a second method of this example, the user can use sequential flow. In a sequential flow example, the user can tap top tag, then tap the middle tag twice, then tap the right tag 3 times. This sequence can initiate to turn Bluetooth on, turn on GPS, and turn off Wifi. If the user taps bottom tag three times, and then middle tag twice, this pattern will turn off Bluetooth, turn on Wifi. If the user taps the middle tag three times, it can turn off all ten possible control items.

Sequential NFC tag reading patterns can offer a greater multiple of possible sequences than the square of the number of possible NFC tags that can be read. For example, if you have 3 NFC tags, the basic square potential of read combinations is 9. Yet being able to read repeatedly, the same NFC tag in the sequence, but in a rhythmic or timed pattern, can allow even greater variations of potential actions. An example of this is as follows. A user has three NFC tags on a surface. The NFC tags have unique identifiers representing the as tag 1, tag 2, and tag 3. Using the basic patterns, the tags can read 3, 2, 1 or 2, 3, 1. There can also be a repeating tag sequence such as 3, 1, 1, 1, 3 or 2, 2, 3, 1, 1. So the combinations of possible patterns for this invention to initiate an action or variation of actions is greater than the square of the number of tags. As well, in another example of using the sequential read of this invention, the user can read the sequence based on time intervals or rhythmic pattern. A simple example of this can be shown by using one NFC Tag. The user can read that tag ever two seconds. The mobile NFC device of the user can tell them via visual, audio, or haptic feedback, when to read the tag again for the sequence. The user can then read tags in a sequence, with variations on read time intervals, to create even more variations of possible NFC tag read sequences. Thereby creating even greater the number of potential actions or variations of actions that can be controlled or initiated based on this invention.

In another example of the invention, the user is guided via the mobile communication device, to the sequence of NFC tag reads. An example of this is a user places there mobile NFC device over a multiple of NFC tags on a surface. Their NFC phone is placed over the NFC tags. The phone can instruct the user as to the pattern or sequence to read the NFC tags. The phone can show visuals such as arrows, where a step by step instruction, dynamically guides the user a sequence or pattern.

There are many possible uses for this technology. Any situation that has a controllable opportunity for actions or variations of actions where there are more than one action or variation of action that can be chosen, can potentially use this technology to control such actions or variations of actions.

While the invention has been described and illustrated with reference to specific exemplary embodiments, it should be understood that many modifications, combinations and substitutions can be made without departing from the spirit and scope of the invention. For example, an operation described as occurring in software is not necessarily limited to be implemented in software and can be partially, substantially, or completely implemented in hardware. Similarly, an operation described as occurring in hardware is not necessarily limited to be implemented in hardware and can be partially, substantially, or completely implemented in software. Accordingly, the invention is not to be considered as limited by the foregoing description but is only limited by the scope of the claims.

what is claimed as new and desired to be protected by Letters Patent of the United States is:

1. A method of using multiple NFC tags to cause an action to be performed:
reading a first data by a mobile communication device a first NFC tag;
reading a second data by said mobile communication device a second NFC tag;
interpreting by said mobile communication device the first and second data from the first and second NFC tags respectively to at least respectively identify the NFC tags; and
causing by said mobile communication device an action to be performed based on identification of the NFC tags.

2. The method of claim 1, wherein said step of causing by said mobile communication device an action to be performed based on identification of the NFC tags further comprises:
causing by said mobile communication device an action to be performed based on the sequence and identification of the NFC tags.

3. The method of claim 2, further comprising the step of:
interpreting by said mobile communication device the first data to identify an appropriate program related to the first data that should be running on the mobile communication device.

4. The method of claim 3, further comprising the step of:
determining whether the appropriate program resides on the mobile communication device, and if the program does not reside on the mobile communication device, then determining where to download the appropriate program from;
and causing the appropriate program to be downloaded.

5. A method of identifying action to be performed derived from a motioning of a Mobile NFC Device in a pattern over a surface containing a plurality of placed NFC tags, comprising the steps of:
dynamically polling by the Mobile NFC Device a reading of the NFC Tags;
interpreting by the Mobile NFC Device of a sequence of the NFC Tags being read for an action or variation of an action; and
causing by said Mobile NFC Device said action or variation of actions, based on the users dynamic pattern of motion of the Mobile NFC Device over the strategically placed NFC Tags on the surface where the Mobile NFC Device is Motioning.

6. A method of reading multiple NFC Tags by an Mobile NFC Device, comprising:
reading at least two NFC tags from a field of a plurality of NFC tags; and interpreting the reading of said at least two NFC tags, where each unique sequence can create a multiple number of possible actions, where said multiple number of possible actions is greater than the number of NFC tags in the plurality of NFC tags.

7. A method of reading an NFC Tag multiple times by a Mobile NFC Device, comprising the steps of:
reading by a Mobile NFC Device an NFC tag in a pattern, where the NFC tag is read in a pattern defined to the user on their Mobile NFC Device via visual, auditory, or haptic feedback; and
where the pattern can cause a initiation of a specific action or variation of an action.

8. The method of claim 7, wherein said patter is a timed pattern or rhythmic pattern.
